(19) United States
(12) Patent Application Publication
(10) Pub. No.: US 2014/0074552 A1
(43) Pub. Date: Mar. 13, 2014

(54) LEAD BIDDING SYSTEM AND METHOD

(71) Applicant: Madison Logic, Inc., New York, NY (US)

(72) Inventors: Eric Matlick, Mantauk, NY (US); Cynthia Hyunh, Nutley, NJ (US); Vincent Henri Lucien Turk, New York, NY (US); Tai Denh Mong, Fresh Meadows, NY (US)

(73) Assignee: Madison Logic, Inc., New York, NY (US)

(21) Appl. No.: 14/023,073

(22) Filed: Sep. 10, 2013

Related U.S. Application Data
(60) Provisional application No. 61/699,157, filed on Sep. 10, 2012.

(51) Int. Cl. G06Q 30/02

(52) U.S. Cl. CPC G06Q 30/0201
USPC 705/7.29; 705/26.3

(57) ABSTRACT

A lead bidding system and methods allows users to bid on leads based on dynamically qualified electronically transmissible documents and dissemination of those leads. The system and methods reduce the barrier to conversion associated with interacting with electronically transmissible documents and also provides a technique to create customized leads.

### CROSS REFERENCE TO RELATED APPLICATION

This application claims the benefit of U.S. Provisional Patent Application No. 61/699,157, entitled “Lead Bidding System and Method”, filed on Sep. 10, 2012, which is hereby incorporated by reference in its entirety.

### BACKGROUND

The invention relates generally to a bidding system based upon the dynamic generation of leads. More particularly, the inventive techniques relate to generating leads based on interactions of users with qualified electronically transmissible documents and distributing the leads to successful bidders.

Vendors of particular products and/or services may entice users to purchase products based upon advertisements and/or information centered around the use of their products. As used herein, the term “assets” may refer to items centered around a particular subject matter, such as electronically transmissible documents pertaining to a particular product or subject matter. For example, typical assets may include technical and/or marketing documentation in the form of white papers, technical papers and documents, technical videos, webinars, and/or audio files describing particular features, use cases, or other topics of interest pertaining to vendor's products and/or services. In some cases, vendors provide these assets as a tool to focus a user's attention on the vendor's product or a particular field of the vendor. Generally speaking, such documentation may be provided to web users via a publisher's web page accessed by the web users. In certain scenarios, a vendor may offer the assets of one or more publishers or other providers, and their business model allows for realization of revenue based upon certain user activities with respect to the offered assets.

The way in which users interact with the assets provided by vendors can be a form of business intelligence. Business intelligence regarding competitors and target markets is very valuable for a company or an advertiser. It allows them to see what the competitor is doing or how customers are using their assets. For example, a company may want to know certain information about its competitors to more effectively strategize a business plan and about itself to make key business decisions. Further, an advertiser may want to know certain information about its target customers to customize ads accordingly.

Traditionally, companies have acquired information about customers based upon requesting user information prior to providing access to an asset. By offering something of value to a customer in exchange for that person's contact information, companies have sometimes been able to glean information about a potential customer. For example, white papers are often offered as free downloadable content, and a user is prompted with a form to fill out when they choose to download the white paper. Unfortunately, these forms are oftentimes perceived to be lengthy and time consuming for a user. Accordingly, the user may choose to abandon interaction with the asset. As a result, a barrier for conversion is created because users will decline to fill out the form. This barrier for conversion causes less to be known about potential customers and competitors.

Further, even when users complete the forms to interact with the asset, traditional systems monitor only very basic information about the user's interaction with the asset. For example, after a user has downloaded a white paper, traditional lead generating systems monitor and/or store a minimal amount of information such as who downloaded the content and a brief description of the content. This minimal information is not sufficient to provide customized leads that are tailored based on a company's or advertiser's needs. There is a need for improved techniques for dynamic lead generation that can be configured according to certain requirements.

### BRIEF DESCRIPTION OF THE INVENTION

The present disclosure provides a novel system and method designed to respond to such needs. In accordance with an embodiment, a method is provided for obtaining user information with the goal of reducing an amount of information that a user has to provide before interacting with an asset, such as digital content, while still capturing useful information about the user. In an exemplary embodiment of the method, a user key is provided from the user's system, such as IP address or the like. The lead host determines whether the user is known based upon the user key, and, if so, determines if the desired information about the user is already known in the system. If the user is not known or desired information about the user is not known, the lead host may poll external user information repositories for the desired information.

If, at any time, the lead host is able to obtain the desired information, either from the internal lead repository or an external user repository, user prompts requesting this information may be skipped. However, if the information cannot be obtained via automatic acquisition, the user may be prompted for the desired information. By first attempting to identify and determine characteristics of a user through automatic acquisition, the barrier for converting a customer into a lead may be reduced. For example, by reducing the frequency that a user will have to fill out a burdensome form, potential obstacles for a user interacting with the asset may be reduced.

In another exemplary embodiment, a method is provided for monitoring and storing interpolated lead data. The lead data is dynamically created based on combining the type of asset (i.e. content, event, or the like), the type of asset interaction (i.e. download, attend, register, read/like/share, or the like), and classification data (i.e. timeliness of content, competition relevance, subject matter groupings, or the like). The price for the lead data may be affected by determining the value of all three components after they are combined. As a means to illustrate, but not to limit the scope of the disclosure, an example of lead data that can be bid on may be the number of times a company downloaded a white-paper within the last month (timeliness). The minimum price that would be set for this lead data may be scaled based on the time window selected as well as the asset and asset interaction type.

In addition, an embodiment of the disclosure also provides a system to deliver digital content to successful bidders. There could be one or a plurality of successful bidders. The price could be real time or historical, meaning fixed. The content may be delivered in near real time to successful bidders or may be delivered in phases. In order to obtain specific lead information, the entity requesting lead information must provide user contact lists. The user contact lists may contain either specific or non-specific lead information. The user contact lists generally include information related to user's address, phone number, email address, place of employment, business address, or the like. In one example of a contact list, the entity requesting information provides a list of who its competitors are, with certain information about them, and it also provides a list of competitors about whom information is desired.

In another embodiment, the lead host will suggest content that is relevant to the bidder after the purchased content has been delivered. For example, if the bidder purchased information about company B's webinar attendance for the month of June, the lead host may suggest that the bidder also purchase information about company B's webinar registrations for the month of June. Further, vendors may provide exclusion lists that, among other things, could specify that any lead information should not include data about certain competitors. That way, a vendor can see specific data relevant to its most important competitors, while ignoring others.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a system for a lead bidding system;

FIG. 2 is a flow chart illustrating exemplary logic for obtaining user information as discussed in FIG. 1;

FIG. 3 is a diagrammatical overview illustrating a lead generation system;

FIG. 4 is a flow chart illustrating a process for bidding on the leads generated from FIG. 3; and

FIG. 5 is a flow chart illustrating a process for reporting leads.

### DETAILED DESCRIPTION

As discussed in detail below, embodiments of the present invention include a system and methods for generating custom leads based, in part, on user information that is already known in the system or is obtained from external user repositories, and allowing bidders to bid on and purchase the leads. Traditionally, users must fill out sometimes burdensome forms in order to interact with an asset, which may cause the user to abandon the asset altogether and a lead may be lost. Further, there is a need for customized lead data that is more useful for entities making business decisions. The embodiments disclosed provide solutions for these issues. For example, a method for obtaining user information automatically without prompting a user to fill out a lengthy form is disclosed. In addition, a method to generate custom lead data that involves collecting information relating to the type of asset, how the asset was interacted with, and certain classification data is disclosed. These methods provide the information for a better system that allows bidders to bid on custom lead data and distributes the lead data to the successful bidder(s).

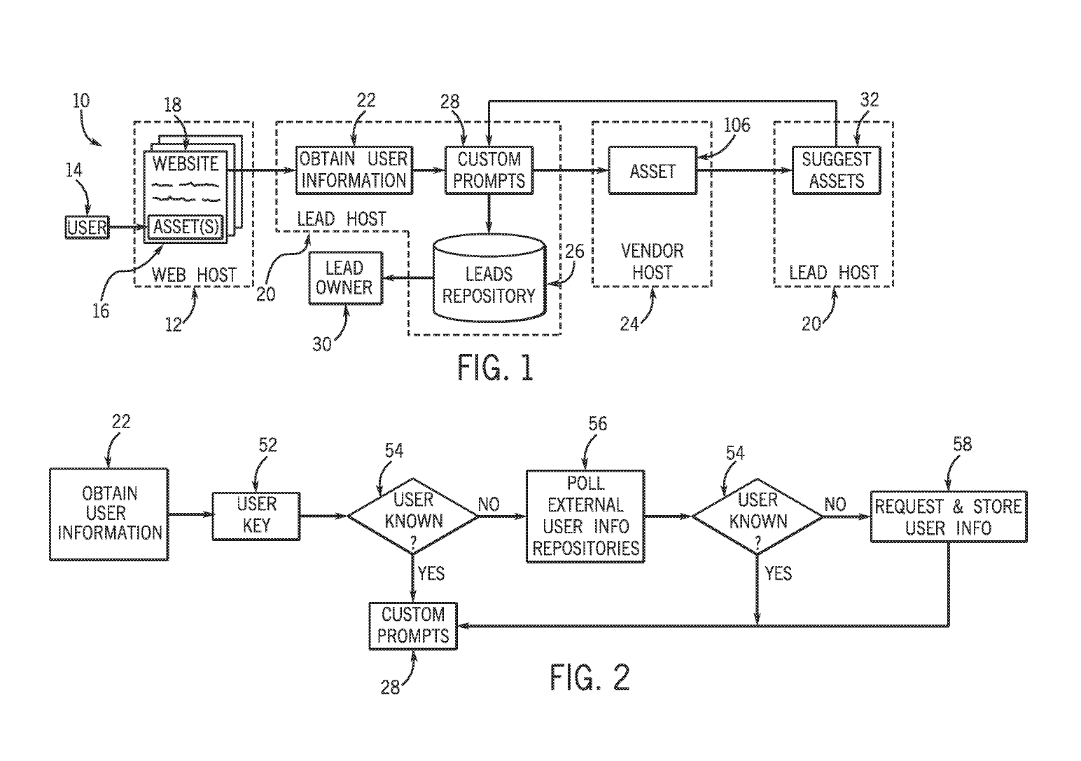

Turning now to the figures, and referring first to FIG. 1, which is a diagrammatical overview of a lead bidding system 10, the lead bidding system 10 may be useful to facilitate leads, such as business intelligence information regarding a user, by enticing a user to interface with assets of the system 10. The leads may be used to provide business intelligence to vendors providing the assets and other entities interested in the lead information. Further, the leads may be a source of revenue for a lead provider, who may sell the leads to the vendors and/or other entities. In a lead bidding system 10 transaction, a web host 12 may present a user 14 with assets 16 the user 14 may interact with via a website 18. The user 14 may provide an indication of a desire to interact with a particular asset 16 provided by the web host 12. This indication may be provided to a lead host 20, which may identify the user 14, obtain additional information from the user 22, supply access to the asset of interest (which may be stored at a vendor host 24), and record the user's interaction with the asset of interest in a lead repository 26. The web host 12, lead host 20, and the vendor host 24 may be computers and/or computer storage devices useful for processing data, as specified herein.

In some embodiments, the user 14 may access a particular vendor's website 18 to obtain information about the vendor's products. The vendor's website 18 may include a list of one or more assets 16, which, in some embodiments, may be suggested by the lead host 20. The list of one or more assets 16 may reference an asset 16 that may be interacted with in a plurality of ways.

Depending on whether the user 14 is interested in an asset referenced in the list of assets 16, the user 14 may choose to interact with one or more of the assets 16 in the list. For example, the user 14 may click a link provided in the list of assets 16, thus representing a desire to interact with a particular asset 16 of interest in the asset list.

Once the user 14 has expressed an interest in a particular asset 16 provided in the asset list, the lead host 20 may attempt to obtain information about the user 104 as will be discussed in more detail with regards to FIG. 2 below. In some embodiments, additional information beyond standard user information may be desired. For example, a lead host 20 may desire to understand particular aspects of the user 14 or a vendor may desire to understand specific information relating to users 14 who are interested in a particular asset 14. To obtain this additional information, the lead host 20 may display custom prompts 28 to the user 14. Once the user 14 has completed the custom prompts 28, the user 14 will then be able to access the asset 16, which may be stored on the vendor host 24. Additionally, the lead host 20 may track the user's interaction with the asset 16 and store the user information along with the additional data provided from the custom prompts 28 and any interactions the user 14 has performed with regards to the asset 16 in the lead repository 26, which may be a database, flat file, or any other data container.

Accordingly, by tracking the user's 14 interactions with the asset 16, the lead host 20 has generated lead information. Thus, a lead owner 30 that successfully purchases and/or has rights to the lead information may then access the lead information. For example, the lead owner 30 may query the lead repository 26 for specific lead information or the lead host 20 may provide (e.g., via Internet transmission) the lead information at specific intervals. After the user interacts with the asset 16, the lead host 20 may, in some embodiments, suggest other content 32 that may be relevant to the user 14. For example, the lead host 20 may determine that users 14 that interacted with a first asset 16 are likely to enjoy a second asset and may provide a suggestion that the user interact with the second asset. Accordingly, additional user interaction is encouraged, which may increase the likelihood of further lead information being generated. For example, if the user 14 selects a suggested asset 32, the lead host 20 may again provide custom prompts 28 and generate lead information in the lead repository 26.

One way to increase user interaction with assets may be to remove unnecessary hurdles between the user and the asset. For example, as discussed above with regards to FIG. 1, a lead host may obtain user information such that the user does not have to repeatedly enter this information each time the user desires to interact with an asset. A method to obtain user information (e.g., block 22 of FIG. 1) utilized by the lead host 20 of FIG. 1 is illustrated in more detail in FIG. 2. The method begins with a computer (e.g., the lead host) obtaining a user key (block 52) to identify the user. For example, in some embodiments the user key may be an IP address or the like. The lead host may determine whether the user is known (decision block 54) by the system based upon the user key. If the user is known, the lead host may display custom prompts 28 to the user, which may be prompts that request specific information from a user other than information that is already known by the system. If the user is not known by the system, the lead host may poll external user information repositories (block 56) to acquire relevant information about the user. For example, the lead host may utilize an application programming interface (API) to communication with and obtain user information from the external user information repositories. In some embodiments, the API may enable third party partners (e.g. business to business partners) to interface with and provide information to the lead host in response to requests made via the API. When a user requests interaction with an asset, and the lead host is unable to determine who the user is based on the user key, the API may automatically send requests to the third party partners for the desired information. If user information is found in the third party partners' system, the third party partners may respond with the information via an API response. In some embodiments, the API may be available as a web service or remote procedure call. Depending on the response from the third party partners, the lead host may then determine whether the user is known (decision block 54). If the user is known, then the computer (e.g., the lead host) may display the custom prompts (block 28), as discussed above. If the user is not known, the computer may request and store user information (block 58) in order to obtain and remember the user information. Accordingly, the user information will be available in the future, when the user attempts to interact with another asset. Furthermore, this user information may be useful in providing information on the user as a lead, if requested. Generally, the prompts for user information at this stage may be more thorough since the lead host was unable to identify the user based on internal and external sources. After the lead host requests and stores the user information (block 58), the lead host may display custom prompts (block 28) to obtain additional information about the user that was not previously captured in the basic user information request. By using the user key to obtain known information about the user from internal and external repositories before requesting the user information, user interaction with an asset may increase by lowering the barrier for interaction (e.g., prompting the user with fewer questions).

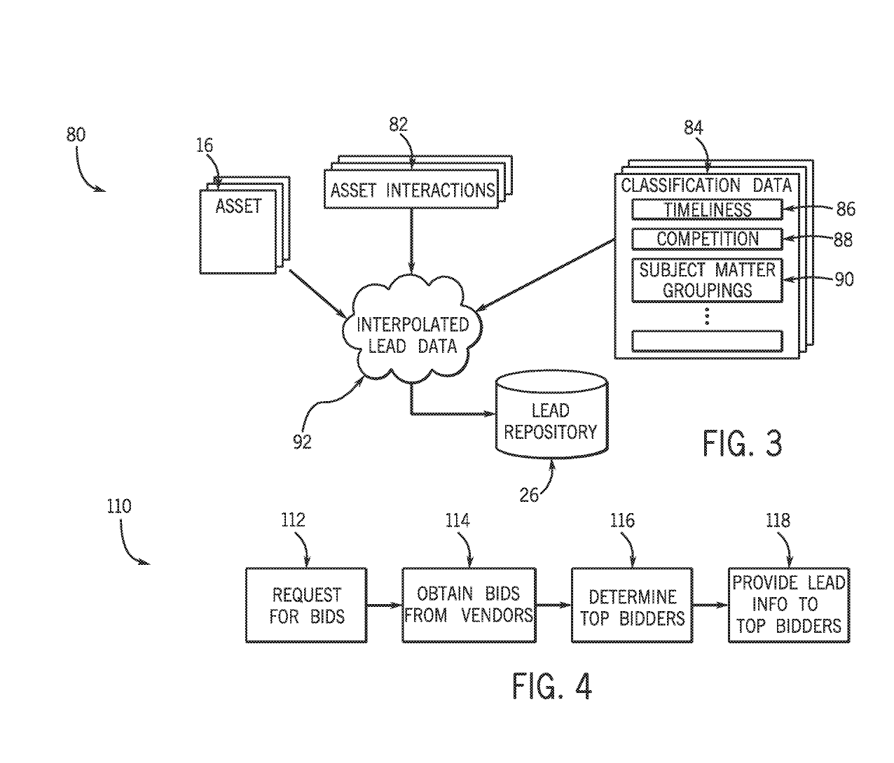

Many forms of business intelligence relating to the user and the assets may provide leads for clients. FIG. 3 is a diagrammatical overview of an embodiment of the lead generation system 80 that creates useful leads for clients. As illustrated in FIG. 3, informational components (e.g., asset information 16, asset interaction information 82, and classification data 84) may be combined to dynamically generate tailored lead data. While particular examples of each of these components will be provided, these examples are not intended to limit the scope of this disclosure. Assets 16 refer to a plurality of things comprising events or content that are provided to entice users to a vendor site or product. For example, assets 16 may include webinars, case studies, white papers, or the like. Asset interactions 82 can be generally defined as the interactions a user does with an asset 16. For example, in some embodiments, asset interactions 82 may include downloading, attending, registering, reading/liking/sharing content, and the like. Assets 16 and asset interactions 82 may be combined to create interaction types. Interaction types are generally defined as a combination of the assets 16 and the way with which they were interacted. For example, interaction types may include downloading a white paper, attending a live event, registering for a live event, or reading/liking/sharing an article.

In addition to providing interaction types in a lead, other information may also be useful. For example, in some embodiments, a third component used to generate lead data is classification data 84, which is a plurality of classifications associated with interaction types to make the lead data more configurable. For example, classification data 84 may include timeliness 86, competition relevance 88, subject matter groupings 90, etc. Using the classification data 84, the number of applicable leads may be tailored to specific criteria. For example, filtering windows may result in vastly different number of leads that will be generated. Further, these windows may result in different qualities of data. Accordingly, depending on how the classification data 84 qualifies an asset 16, the lead data may be more or less valuable than other uses of the classification data 84. Accordingly, variable prices of the lead data may be commanded. In one embodiment, timeliness classification data 86 may provide a window of time with which to focus the lead generation. For example, the timeliness classification data 86 may provide a window of interactions of the asset 16 that took place between 4-6 months ago. In some embodiments, timeliness classification data 86 may refer to how recently the asset 16 was created. The time window when interaction took place with the asset or how new or old an asset 106 is may affect the lead information's price. For example, depending on how the timeliness classification data 86 is used, the freshness of the data may change. In some embodiments, fresher leads may command a higher price, while staler leads may command a lower price.

Another classification data 84, competition relevance classification data 88, may refer to the degree with which companies compete with one another. For example, if company A and B are the two leading companies in the computer manufacturing industry, and company A requests information about company B, the competition relevance 88 would be high because the two companies are in close direct competition with one another. As a result, the price for the information that company A requested may be higher. Likewise, if company A requested information about company C, who is ranked tenth in the computer manufacturing industry, the competition relevance 88 is lower and the price may be lower. Another classification data 84, subject matter groupings 90, may also affect the price of requested information. The number of markets a company is in may affect the coverage of the competition relevance classification data 88. For example, if a company sells food products, consumer electronics, and household items, the competition relevance classification data 88 may pull more leads than a boutique that sells only high-end electronic devices. Accordingly, in some embodiments, because the number of markets of the diversified company is increased, the price for leads may also increase. In other embodiments, leads for the high-end electronic device boutique may command a higher price, because it may be more difficult to find leads that have high competition relevance classification data 84 for a very specific competitor type.

In some embodiments, subject matter groupings 90 may also be used in generating leads. Subject matter groupings 90 may include: the subject matter of the asset (e.g., assets related to servers, databases, cloud computing, etc.), a field related to the asset owner (e.g., imaging and printing, consumer electronics, apparel, etc.), or classification data of the asset (e.g., the size of the asset, costs of the asset, etc.). Any other type of data used to classify information should be understood by one of ordinary skill in the art to be capable of being utilized by the system 80. Accordingly, the combination of the interaction type and classification data enables custom lead data to be generated that may serve as valuable business intelligence for an entity.

As illustrated in FIG. 3, the asset 16, asset interactions 82, and classification data 84 may be used to interpolate lead data 92, which may be business intelligence information useful to a company. The interpolated lead data 92 may be stored in the lead repository 26. As mentioned above, the lead repository 26 may be any type of data structure and it will generally include fields that store information related to the user who interacted with the asset, asset type, asset interaction, and classification data, like timeliness date/timestamps, competition relevance, and subject matter groupings.

In other embodiments, the system's function that stores the interpolated lead data 92 in the lead repository 26 may call stored procedures, in-line code, or other means to execute database operations. Further, the lead repository 26 may perform backup operations to adequately protect the stored leads. The lead repository 26 may be running on the lead host or on a server accessible by the lead host and the data stored in the lead repository 26 may be encrypted or protected by a firewall to ensure data integrity.

After the leads are stored, the lead host may enable purchases to purchase leads. For example, in some embodiments bidders may bid on the lead data and the lead host may distribute the lead data to successful bidders. FIG. 4 is a flow chart illustrating a process for bidding on the leads 110 generated from FIG. 3, in accordance with an embodiment. In the depicted embodiment of the application, the bidding function begins with the lead host 20 (shown in FIG. 1) requesting for bids 112 from vendors. For example, the lead host may generate automatic e-mails, publish websites, etc. that provide notice of an active bid process. Upon receiving this notice, vendors may submit their bid to the lead host, which obtains all the bids from the vendors 114 for particular lead information. The lead host may be capable of operating multiple auctions simultaneously and, therefore, may be able to associate vendor bids with a specific set of lead data in order to keep the different auctions separated. After the lead host obtains the bids 114, it may determine which vendor is the successful bidder 116. However, the lead host may allow for more than one bidder to receive the data. For example, in one embodiment of the application, the successful five highest bidders may receive the lead information or a progressively reduced portion of the lead information. In another embodiment, though, only the successful bidder may receive the lead information. The lead host may be configured to accommodate auctions with varying rules regarding how many bidders should receive the lead information. After the successful bidder(s) are determined 116, the lead host may provide the lead information to the successful bidder(s) 118. This may be generally done by electronically transmitting the lead information from the lead host 20 (shown on FIG. 1) to the successful bidder(s) via the Internet. For example, the lead host may deliver the lead information as a batch all at once immediately, in near real-time, to the successful bidder(s). In an alternative embodiment of the application, the lead information may be distributed over time in varying sizes to the successful bidder(s).

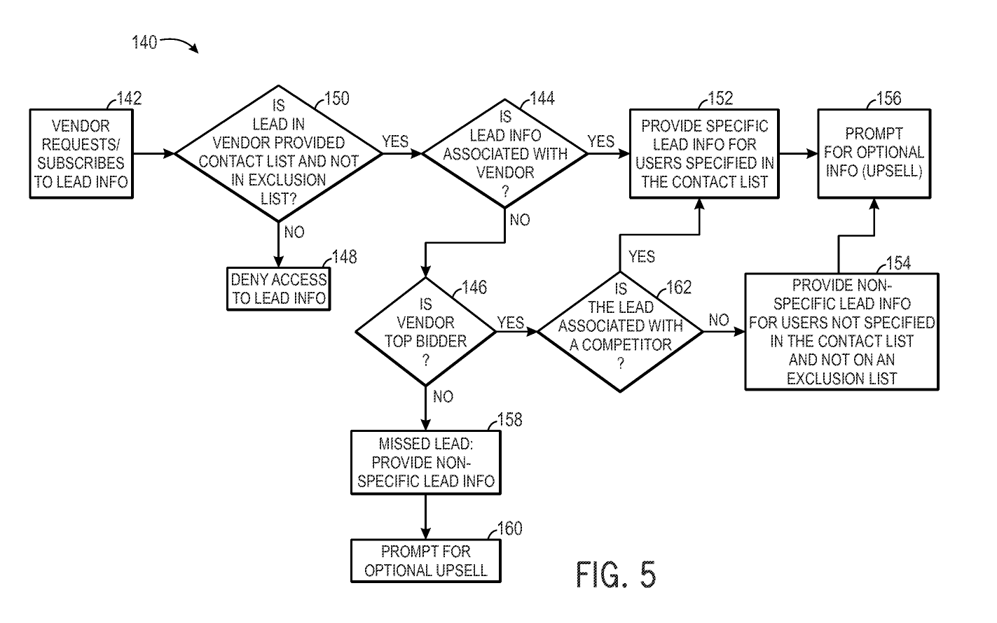

In some embodiments, vendors may initiate the bidding process by requesting or subscribing to lead information. FIG. 5 is a flow chart illustrating a process for reporting leads 140, in accordance with this embodiment. The lead host determines if the vendor has provided a user contact list and also whether the vendor's exclusion list (decision block 150). In some embodiments, if the lead is not in the contact list and/or the lead exists in the exclusion list, access to the lead info will be denied (block 148).

The user contact lists may allow the lead host to track a list of entities that vendors want information on in the future. For example, a vendor may supply a list of competitors and the vendor may also supply a separate list of competitors it wants information on. This information increases the lead host's ability to provide customized leads focused on information associated only with the vendor's tracked competitors. In some embodiments, the user contact list is used to identify users, which may be accessed by the lead host. This may decrease the chance that the lead host will have to prompt the user with a lengthy form to fill out, further reducing the barrier to conversion discussed above. Further, the exclusion lists may enable vendors to specify particular entities that should not generate leads. For example, the exclusion lists may cause the system to ignore leads from specific companies which the vendor has no interest in.

The next step from the lead host is to determine whether the lead information is associated with the requesting vendor (decision block 144). The information from the lead associated with the vendor is automatically granted to the owner (e.g., the vendor) free of charge.

If the requested lead information is not associated with the vendor, the lead host determines whether the vendor is a successful bidder 146. If the requesting vendor is not a successful bidder, the lead host may provide non-specific lead information to the vendor (block 158). The lead host may also prompt the vendor to purchase optional information that is relevant to the lead information requested for an additional charge (block 160). For example, if the vendor has requested lead information relating to a competitor's downloads of smart-phone related white-papers, the lead host may suggest the vendor also purchase a competitor's downloads of other hand-held device related white-papers.

When the lead is not associated with the vendor but the vendor is the top bidder, the lead host will then determine if lead is associated with a competitor provided by the vendor (block 162). This determines the type of data provided to the vendor. When the lead is not associated to any of the vendor's specified competitors, the lead host will provide non-specific lead information (block 154). For example, such information may include a simple representation that a particular user interacted with an asset on a particular date.

If the lead is associated with the vendor's competitor, the lead host may, in some embodiments, provide more detailed lead information (block 152). For example, a more detailed message may be provided that a particular user has done a specific action on/against a particular from a particular competitor on a particular publisher's web site. For example, this message could be provided in a format such as “this person has done [a specific action] against [asset name] from your competitor [competitor name] on [publisher site],” where the bracketed items represent dynamic data obtained via the system.

Regardless of which scenario occurs, when a lead info is displayed in detail (block 152), the lead host may prompt the vendor to purchase optional information that is relevant to the lead information requested (block 156).

The various embodiments described herein provide a system and methods for generating customized leads and allowing bidders to bid on and receive those leads if successful. The obtain user information method is able to reduce the barrier for conversion of leads by trying to automatically obtain the user's information without having to burden the user with a lengthy form. The leads are customized based on various factors including how the asset was interacted with and certain classification data such as timeliness, competitor relevance, or subject matter groupings. This customization of leads allows entities to gather business intelligence that may enhance business planning.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the lead host may operate vertically, meaning the application and data structure run on the same hardware, or the lead host may operate horizontally meaning the application and data structure are integrated but running on different hardware. Similarly, the various features described, as well as other known equivalents for each feature, may be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A lead creation system, comprising:
a lead host computer configured to provide interaction with a vendor's electronically transmissible document to a user of the lead host in exchange for information relating to the user; wherein the information relating to the user is useful for generating leads comprising business intelligence relating to user's interaction with the vendor's electronically transmissible document and at least a portion of the information relating to the user may be obtained without user intervention.

2. The lead creation system of claim 1, wherein the lead host computer is configured to identify the user based upon a user key and obtain the at least portion of the information based upon the user key.

3. The lead creation system of claim 2, wherein the user key comprises an IP address, a media access control (MAC) address, or other identifier of a computer used by the user.

4. The lead creation system of claim 2, wherein the user key comprises an alpha-numeric identifier entered by the user.

5. The lead creation system of claim 1, wherein the at least portion of information is obtained from information stored in the lead host computer.

6. The lead creation system of claim 1, wherein the at least portion of information is obtained from information stored external to the lead host computer.

7. The lead creation system of claim 6, wherein the information is obtained via an application programming interface (API) with a computer external to the lead host computer.

8. The lead creation system of claim 1, wherein the at least portion of information is obtained from information stored in the lead host computer, when available; wherein the at least portion of information is obtained from information stored external to the lead host computer when the at least portion of information is not available in the lead host computer; and wherein the at least portion of information is obtained from a user prompt provided by the lead host computer when the at least portion of information is not available in the lead host computer or external to the lead host computer.

9. The lead creation system of claim 1, wherein the leads comprise at least one of the information relating to the user, identification of the vendor's electronically transmissible document, or information relating to the user's interaction with the vendor's electronically transmissible document.

10. The lead creation system of claim 1, wherein the vendor's electronically transmissible document comprises a web-event, a white paper, a video, an audio file, or a web-page.

11. The lead creation system of claim 1, wherein the interaction comprises: downloading, attending, registering, reading, liking, or sharing the vendor's electronically transmissible document.

12. The lead creation system of claim 1, wherein the lead host computer is configured to qualify the leads based upon classification parameters.

13. The lead creation system of claim 12, wherein the classification parameters comprise at least one of timeliness, competition relevance, or subject matter groupings.

14. A lead bidding system, comprising:
a lead bidding computer configured to:
obtain leads from a lead creation system configured to generate leads from user interaction with a vendor's electronically transmissible documents; and
offer for sale the leads to one or more customers.

15. The lead bidding system of claim 14, wherein the offer for sale comprises notifying the one or more customers of a bidding process and wherein the lead bidding system is configured to obtain bids from the one or more customers, determine one or more successful bidders from the one or more customers, and provide at least a portion of the leads to the one or more successful bidders.

16. The lead bidding system of claim 15, wherein the lead bidding computer is configured to:
accept one or more exclusion lists from the one or more customers and removing leads based upon the exclusion lists.

17. The lead bidding system of claim 15, wherein the lead bidding computer is configured to:
accept one or more inclusion lists from the one or more customers, providing more detail in the leads for leads associated with the inclusion lists and less detail for leads not associated with the inclusion lists.

18. The lead bidding system of claim 15, wherein the lead bidding computer is configured to suggest additional relevant lead information to the one or more customers based upon an identity of the customer, the obtained bids, the successful bidders, or a combination thereof.

19. The lead bidding system of claim 15, wherein the lead bidding computer is configured to:
detect an owner of the electronically transmissible document; and
provide lead information regarding the electronically transmissible document to the owner free of charge.

20. A method, comprising:
providing a reference to a vendor's electronically transmissible document to a user;
upon the user activating the reference, attempting to acquire user information without manual input of the user information;
if unable to acquire the user information without manual input, requesting the user information, via a user prompt;
providing access to the vendor's electronically transmissible document to the user;
monitoring and recording the user's interaction with the vendor's electronically transmissible document;
generating one or more leads based upon the user's interaction with the vendor's electronically transmissible document; and
offering for sale the one or more leads.

21. The method of claim 20, wherein attempting to acquire user information without manual input comprises:
obtaining a user key, wherein the user key identifies the user;
searching for locally-stored user information relating to the user key; and
if no locally-stored user information is found, querying external data providers for remotely-stored user information based upon the user key.

22. The method of claim 20, wherein generating one or more leads comprises:
classifying the recorded interaction with the vendor's electronically transmissible document according to classification data; and
storing the classified data in a leads repository.

23. The method of claim 20, where offering for sale the one or more leads comprises:
notifying customers of potential leads via email or a webpage.

24. A method for reporting leads comprising the steps of:
(1.) receiving a request or subscription to lead information;
(2.) determining if the requested lead information is associated with the requestor and proceeding to step 3 if not, and proceeding to step 5 if so;
(3.) determining whether the requestor is a successful bidder and proceeding to step 4 if not and proceeding to step 5 if so.
(4.) denying access to requested lead information and ending the process;
(5.) determining whether requestor provided a user contact list and proceeding to step 6 if not and proceeding to step 7 if so;
(6.) providing non-specific lead information and proceeding to step 9;
(7.) providing specific lead information for users specified in the contact list;
(8.) providing non-specific lead information for users not specified in the contact list and not on an exclusion list; and
(9.) prompting requestor with optional information.

25. The method of claim 24 wherein the lead information is provided to a requestor via Internet transmission.

26. The method of claim 24 wherein the optional information prompted to the requestor may be related to the lead information requested.

27. The method of claim 24 wherein the lead information is provided to the requestor for free if the lead information is associated with the requestor.

28. The method of claim 24 wherein more than one bidder may be provided the lead information.
